(19) United States
(12) Patent Application Publication
(10) Pub. No.: US 2025/0110671 A1
(43) Pub. Date: Apr. 3, 2025

(54) CLOUD SERVER FOR PROVIDING CLOUD PRINT SERVICE

(71) Applicant: CANON KABUSHIKI KAISHA, Tokyo (JP)

(72) Inventor: MASASHI NAKAGAWA, Kanagawa (JP)

(21) Appl. No.: 18/897,982

(22) Filed: Sep. 26, 2024

(30) Foreign Application Priority Data
Sep. 28, 2023 (JP) 2023-166775

(51) Int. Cl. G06F 3/12

(52) U.S. Cl. CPC G06F 3/1205; G06F 3/1238; G06F 3/1287

(57) ABSTRACT

A cloud server for providing a cloud print service includes at least one memory that stores instructions, and at least one processor that executes the instructions to receive a login request from an image forming apparatus remotely operated by an information processing terminal, acquire a file list from a cloud storage service based on user information acquired in response to the received login request, transmit the acquired file list to the information processing terminal, provide the information processing terminal with a setting screen for changing print settings regarding a printing target file, download the printing target file from the cloud storage service when an instruction for printing the printing target file is received from the information processing terminal, generate a print job based on the downloaded printing target file and the print settings changed in the setting screen, and transmit the generated print job to the image forming apparatus.

### BACKGROUND

### Field of the Disclosure

The present disclosure relates to a cloud server for providing a cloud print service.

### Description of the Related Art

With the recent increase in the use of cloud print platforms, there has generally been systems based on cooperative operations between a print service provided by cloud computing and image forming apparatuses such as printers and digital multifunction peripherals installed in companies.

In a certain use form of a print service, a single device or a plurality of devices is collectively managed on a cloud in units of companies or company organizations. This unit of management is generally referred to as a tenant. The number of devices depends on the scale of the company or customer. Generally, in managing a plurality of devices, there is often assigned an exclusive service engineer performing maintenance works mainly on a device vendor. On the other hand, in managing a single device, an exclusive service engineer is rarely assigned for one device. More specifically, it is demanded that a customer contracting a single device can easily use a print function even if no exclusive service engineer is assigned. As an example of a printing system for easily using a print function, a mechanism allows a user to perform printing simply by registering a mail address for each device and sending document data to the address. As another example of a simplified printing system, a mechanism allows a user to perform printing by selecting printing target document data from a general external cloud storage service and clicking a printing button. These printing systems eliminate the need of installing a vendor-specific printer driver or a special application on a personal computer (PC) used to send a print job, making it possible to omit installation works.

Since works for installing a printer driver and a special application can be omitted in this way, the installation of the above-described printing systems has been facilitated. Although no problem arises in normal printing, these printing systems cannot perform printing with special print settings. Examples of printing with complicated print settings include enlarging/reducing an image, assigning a plurality of pages to a sheet of paper, and enabling a stamp function such as “Confidential” and “Secret”. Although these settings can be made with a printer driver, an operation panel attached to an image forming apparatus having a low display resolution makes it difficult to display and set the relevant setting items.

Japanese Patent Application Laid-Open No. 2005-108103 discusses a system in which an information processing terminal installed in a store acquires print information from an information storage server on a network, displays screens based on the information, receives print settings made by the user, and performs printing on a printer locally connected with the information processing terminal.

However, to build the system discussed in Japanese Patent Application Laid-Open No. 2005-108103, the information processing terminal connected with the printer needs to be installed in the store, increasing trouble of installation.

### SUMMARY

According to embodiments of the present disclosure, a cloud server for providing a cloud print service includes at least one memory that stores instructions, and at least one processor that executes the instructions to receive a login request from an image forming apparatus remotely operated by an information processing terminal, acquire a file list from a cloud storage service based on user information acquired in response to the received login request, transmit the acquired file list to the information processing terminal, provide the information processing terminal with a setting screen for changing print settings regarding a printing target file selected from the file list, download the printing target file from the cloud storage service in a case where a printing execution instruction for printing the printing target file is received from the information processing terminal, generate a print job based on the downloaded printing target file and the print settings changed in the setting screen, and transmit the generated print job to the image forming apparatus.

Further features of the present disclosure will become apparent from the following description of exemplary embodiments with reference to the attached drawings.

### BRIEF DESCRIPTION OF THE DRAWINGS

FIG. 1 illustrates a system configuration according to the present exemplary embodiment.

FIG. 2 illustrates a hardware configuration of an image forming apparatus according to the present exemplary embodiment.

FIG. 3 is a block diagram illustrating a software configuration of the image forming apparatus according to the present exemplary embodiment.

FIG. 4 is a block diagram illustrating a software configuration of a cloud print service according to the present exemplary embodiment.

FIG. 5 is a block diagram illustrating a software configuration of an information processing terminal according to the present exemplary embodiment.

FIG. 6 is a sequence diagram illustrating processing for logging into the cloud print service executed by a web service of the image forming apparatus according to the present exemplary embodiment.

FIG. 7 illustrates an example of a login screen of the web service provided by the image forming apparatus according to the present exemplary embodiment.

FIG. 8 illustrates an example of a main page screen of the web service provided by the image forming apparatus according to the present exemplary embodiment.

FIG. 9 illustrates an example of a web page screen provided by the cloud print service according to the present exemplary embodiment.

FIG. 10 is a sequence diagram illustrating processing for printing document data stored in a cloud storage service executed by the web service of the cloud print service according to the present exemplary embodiment.

FIG. 11 illustrates an example of a print item setting screen according to the present exemplary embodiment.

FIG. 12 illustrates an example of a screen in which a paper feed sheet tab is selected according to the present exemplary embodiment.

FIG. 13 illustrates an example of a screen in which a paper discharge sheet tab is selected according to the present exemplary embodiment.

### DESCRIPTION OF THE EMBODIMENTS

The present exemplary embodiment will be described below with reference to the accompanying drawings. The following exemplary embodiments do not limit the present disclosure. Not all of the configurations described in the exemplary embodiments are indispensable to embodiments of the present disclosure.

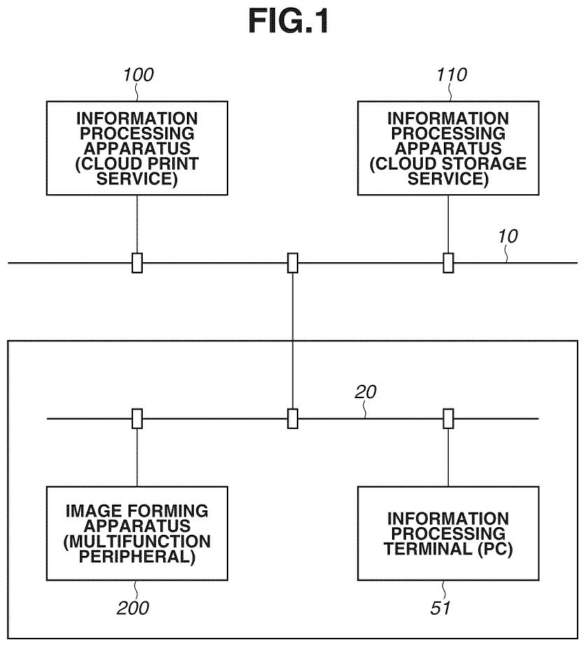

FIG. 1 illustrates a system configuration according to the present exemplary embodiment.

As illustrated in FIG. 1, the system according to the present exemplary embodiment includes, for example, information processing apparatuses 100 and 110, an information processing terminal 51, and an image forming apparatus 200 which are all communicably connected with networks 10 and 20.

The information processing apparatus 100 is a server hosted on a cloud platform and provides connected clients with web services. Particularly, the information processing apparatus 100 is a cloud server for providing print services. The information processing apparatus 100 may also be referred to as a cloud print service 100. The information processing apparatus 110 is a cloud server for providing general-purpose storage services such as “Google Drive®”. The information processing apparatus 110 is referred to as a cloud storage service 110.

The image forming apparatus 200 is a digital multifunction peripheral having a plurality of functions including a copy function, a scan function, a print function, a FAX function, and an E-mail transmission function. Alternatively, the image forming apparatus 200 may be a printer having only a print function. The information processing terminal 51 is a personal computer (PC).

The local network 20 is, for example, an in-house network of a company. FIG. 1 illustrates an example case where a plurality of image forming apparatuses and a plurality of information processing terminals used by a plurality of company members are connected in a company office.

The image forming apparatuses and the information processing terminals communicate with the cloud print service 100 via the Internet, making it possible to use web services and print services provided by the cloud print service 100.

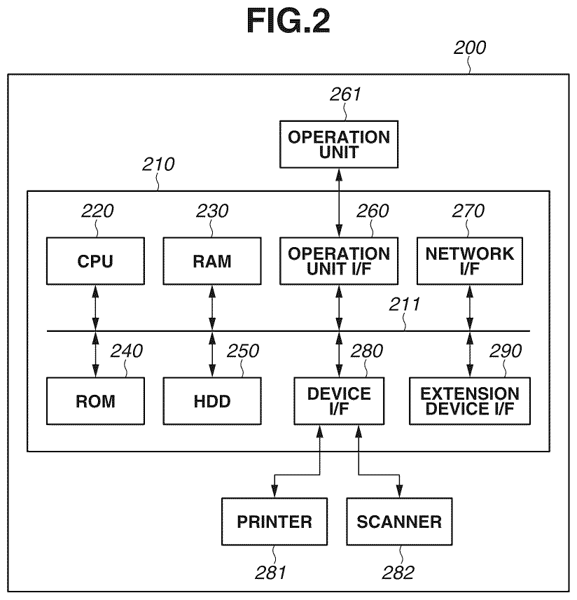

FIG. 2 illustrates an example of a hardware configuration of the image forming apparatus 200 according to the present exemplary embodiment.

In this example, the image forming apparatus 200 is a digital multifunction peripheral including a controller unit 210, an operation unit 261, a printer 281, and a scanner 282. The controller unit 210 includes a Central Processing Unit (CPU) 220, a Random Access Memory (RAM) 230, a Read Only Memory (ROM) 240, a Hard Disk Drive (HDD) 250, an operation unit interface (I/F) 260, a network I/F 270, a device I/F 280, and an extension device I/F 290.

The CPU 220 as the entity of executing a control program built in the image forming apparatus 200 controls operations of devices connected with the controller unit 210 via the interfaces and a memory as a storage medium. The RAM 230 stores programs and data. The programs include the operating system, system software, and application software. The ROM 240 stores the boot program of the system, system programs, and application programs. The ROM 240 may store fonts and other information necessary for the image forming apparatus 200. The HDD 250, a storage device having a larger capacity than the RAM 230, stores the operating system, system software, application software, image data, setting data, print jobs, and user information. When the CPU 220 executes a program stored in the ROM 240, a program stored in the HDD 250 is loaded into the RAM 230. Subsequently, the CPU 220 executes the program loaded into the RAM 230 to process data stored in the RAM 230, the ROM 240, and the HDD 250. Some small multifunction peripherals not having the HDD 250 may be configured to store system software and application software in the ROM 240. Alternatively, the image forming apparatus 200 may be configured to use storage devices other than a hard disk drive (HDD 250), such as a Solid State Disk (SSD) and a flash memory.

The operation unit I/F 260 performs input/output control for the operation unit 261 having a touch panel, and outputs image data to be displayed on the operation unit 261 to the operation unit 261. The operation unit I/F 260 transfers information input from the operation unit 261 by the user to the CPU 220.

The network I/F 270 connects with the network to communicate with an external apparatus on the network.

The device I/F 280 connects the printer 281 and the scanner 282 as image input/output devices with the controller unit 210 to input and output image data. The CPU 220 controls the scanner 282 to read a document image, inputs read image data via the device I/F 280, and stores the image data in the RAM 230 and the HDD 250. The stored image data is subjected to image processing by an application program loaded into the RAM 230 as required. The image data is output to the printer 281 via the device I/F 280 and then printed on a sheet through the control of the printer 281.

The extension device I/F 290 is a wireless transceiver such as a Universal Serial Bus (USB) port and Bluetooth® for connecting a desired optional apparatus. For example, the extension device I/F 290 enables connection of optional apparatuses such as an identification (ID) card reader and a biometrics authentication apparatus.

It goes without saying that the present disclosure is not limited to the configuration in FIG. 2. Any configuration other than the one illustrated in FIG. 2 is also applicable as long as the configuration satisfies the effect of the present exemplary embodiment. For example, a printer not having the scanner 282 is also applicable. With a multifunction peripheral having a FAX function, the controller unit 210 may be provided with an interface for a modem apparatus (not illustrated in FIG. 2). In this case, a modem allows connection with a public telephone line enabling FAX transmission.

The hardware configurations of the cloud print service 100 and the cloud storage service 110 illustrated in FIG. 1 are similar to the configuration of a common information processing server. The hardware configuration of the information processing terminal 51 is similar to the configuration of a common PC.

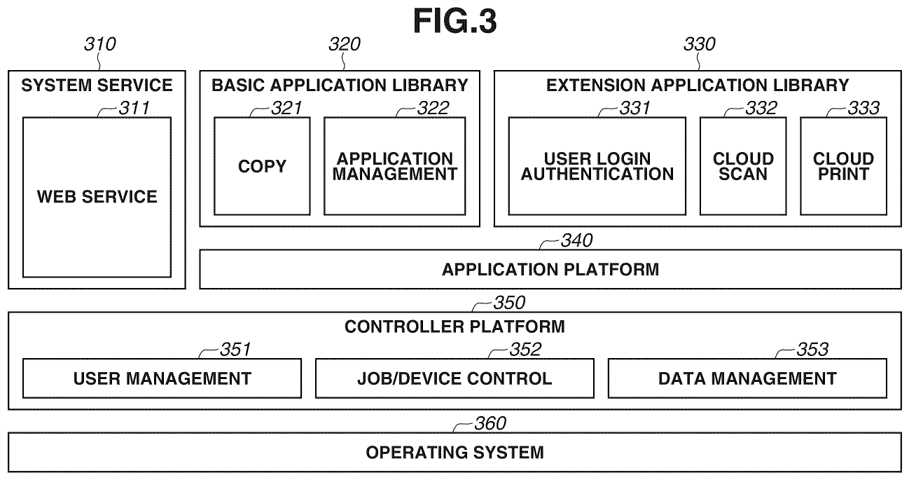

FIG. 3 is a block diagram illustrating a software configuration of a program to be executed by the CPU 220 of the image forming apparatus 200 according to the present exemplary embodiment.

An operating system 360 provides various resource management services and frames optimized for controlling embedded systems for software operating on the services and frames. Examples of various resource management services and frames provided by the operating system 360 include multi-task management for substantially enabling parallel operations of a plurality of pieces of processing by managing a plurality of processing execution contexts by the CPU 220, and inter-task communication for implementing synchronization and data exchange between tasks. The operating system 360 also provides memory management, interrupt management, various device drivers, local interfaces, and protocol stacks implementing networks, communications, and other various protocol processing.

The controller platform 350 includes a user management module 351, a job/device control module 352, and a data management module 353. The user management module 351 provides an application with a mechanism for managing local users in the image forming apparatus and their authentication information by using the RAM 230 and the HDD 250. A login application implements user login control on the image forming apparatus by using authentication information for local users managed by the user management module 351. The job/device control module 352 executes an image forming job such as a scan job, a print job, and a copy job while controlling the printer 281 and the scanner 282 according to an instruction from the application. The job/device control module 352 manages device statuses and errors of the printer 281 and the scanner 282.

The data management module 353 manages image data and various setting data required to execute an image forming job. The data management module 353 manages a job execution history, counter information, and various data controlled by applications.

The system service 310 is a software module having a function of updating programs of the controller platform 350 and the operating system and a function of managing device information and network settings. The system service 310 configuring a web service 311 enables remote operations from a remote terminal such as the information processing terminal 51.

An application platform 340 is middleware that allows the use of the mechanisms of the operating system 360 and the controller platform 350 from various applications in a basic application library 320 and an extension application library 330 (described below).

The basic application library 320 indicates an application group for providing basic functions of the image forming apparatus stored in the ROM 240 or the HDD 250 from the initial state when the image forming apparatus is purchased. The extension application library 330 indicates a freely-selected application group separately installed to extend the functions implemented by the image forming apparatus. Each application displays screens on the operation unit 261 and implements various functions according to user operations received by the operation unit 261.

FIG. 3 illustrates an example where the basic application library 320 includes copy 321 and application management 322. The copy 321 is an application that executes a copy job for scanning a document and printing the document on paper. The application management 322 is an application that manages the installation and uninstallation of extension applications in the extension application library 330.

FIG. 3 illustrates, for example, a state where extension applications (user login authentication 331, cloud scan 332, and cloud print 333) are installed in the extension application library 330.

The user login authentication 331 is an application that displays a screen for inputting user authentication information on the operation unit 261 and implements user login processing on the image forming apparatus by using the user authentication information input from the operation unit 261. The user login authentication 331 implements the user login processing by using not only the user authentication information input from operation unit 261 but also user authentication information read from an ID card reader or a biometrics authentication apparatus connected via the extension device I/F 290. The user login authentication 331 communicates with the cloud print service 100 via the network I/F 270, compares the user authentication information managed on the cloud print service 100 with the user authentication information input on the image forming apparatus, and performs the user authentication.

The user login authentication 331 may perform the user authentication by comparing the user authentication information managed by the user management module 351 with the input user authentication information.

The cloud scan 332 is an application that communicates with an indefinite cloud storage service 110, executes a scan job on the image forming apparatus to read an image file, and transmits the read image file to the cloud storage service 110.

The cloud print 333 is an application that communicates with the cloud print service 100, acquires printing target image data from the cloud print service 100, and executes a print job on the image forming apparatus. The cloud print 333 transmits a result of executing the print job to the cloud print service 100.

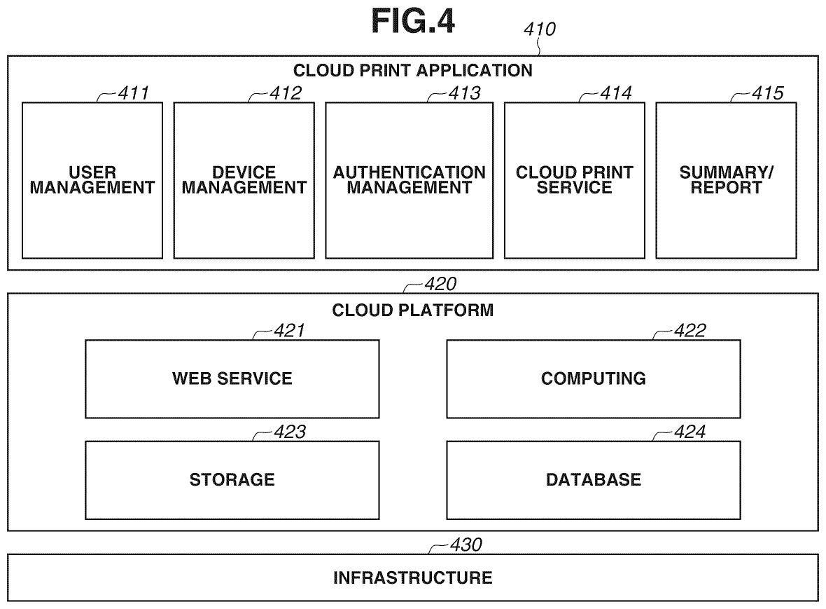

FIG. 4 is a block diagram illustrating a software configuration of the cloud print service 100 according to the present exemplary embodiment.

The infrastructure 430 is the basis for the cloud server to provide various services, and includes a server, a virtual machine, a cloud storage, a network, and an operating system.

A cloud platform 420 is a framework for providing a cloud print application 410 with common basic functions by using the infrastructure 430, and includes a web service 421, computing 422, a cloud storage 423, and a database 424.

The cloud print application 410 indicates various application groups operating on the cloud platform 420. The cloud print application 410 includes user management 411, device management 412, authentication management 413, a cloud print service 414, and a summary/report 415.

The user management 411 is a web application that provides a web portal screen for consolidating user information on the cloud print service 100 by using the web service 421. This web portal screen allows the user to add management target users, and change and delete setting information. The user management 411 manages target user information by using the database 424. The user management 411 is a web application that provides an Application Programming Interface (API) for receiving a user authentication instruction from the user login authentication 331 operating on the image forming apparatus.

The device management 412 is a web application that provides a web portal screen for consolidating devices on the cloud print service 100 by using the web service 421. This web portal screen allows the user to register management target devices (image forming apparatuses), edit the registered information, and cancel the registration. The device management 412 is a web application that provides an API for receiving a device registration instruction from the user login authentication 331 operating on the image forming apparatus.

The authentication management 413 is a web application that provides a web portal screen for setting a user login authentication method by using the web service 421. This web portal screen allows the user to set the user login authentication method for devices consolidated on the cloud print service 100. The authentication management 413 manages the target user login authentication method by using the cloud storage 423 or the database 424. The authentication management 413 is a web application that provides an API for receiving a setting information acquisition instruction from the user login authentication 331 operating on the image forming apparatus. The authentication management 413 also has a function of accessing various web portal screens provided by the cloud print application 410 and a function of performing the user authentication when an API call is made.

If the user management 411, the device management 412, and the authentication management 413 executed on the cloud print service 100 operate in association with the user login authentication 331 executed on the image forming apparatus, the user can log into the cloud print service 100 by using the consolidation user authentication method and the authentication information in any device managed on the cloud print service 100.

The cloud print service 414 is a web application that provides an API for receiving a printing target document acquisition instruction and a printing execution instruction from the cloud print 333 executed on the image forming apparatus by using the web service 421. The cloud print service 414 receives the printing target document acquisition instruction and returns a list of printing target documents stored in the target cloud storage. The cloud print service 414 receives the printing execution instruction and converts a format of the data into a data format printable by the image forming apparatus by using the computing 422. The cloud print service 414 is also a web application that provides an API for receiving print jobs transmitted from the information processing terminals 51, 52, and 53, and an API for receiving a print job acquisition instruction from the cloud print 333.

If the cloud print service 414 on the cloud server operates in association with the cloud print 333 executed on the image forming apparatus, the user can execute the same print workflow in any device managed on the cloud print service 100.

A summary/report 415 is a web application that provides an API for receiving a job execution result transmitted from the cloud scan 332 and the cloud print 333 executed on the image forming apparatus by using the web service 421. The summary/report 415 is also a web application that summarizes the received job execution results and provides a web portal screen for displaying the summary results by using the computing 422.

The web portal screens and APIs provided by the various cloud print applications 410 are separately managed on a tenant basis. For example, a different Uniform Resource Locator (URL) is generated for each tenant. Data managed by the various cloud print applications 410 is also separately managed on a tenant basis.

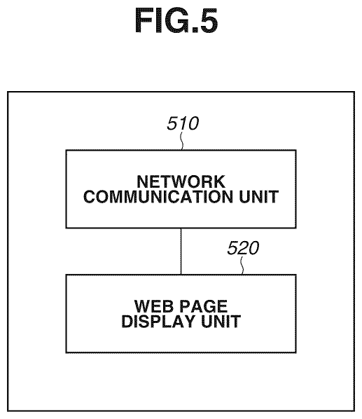

FIG. 5 is a block diagram illustrating a software configuration of the information processing terminal 51 according to the present exemplary embodiment.

The program operating on the information processing terminal 51 includes a network communication unit 510 and a web page display unit 520. The network communication unit 510 is a module for performing data communication with the cloud print service 100 connected via the networks 10 and 20. The web page display unit 520 is a web browser that displays various web portal screens provided by the cloud print service 100 and receives user operations on the screens.

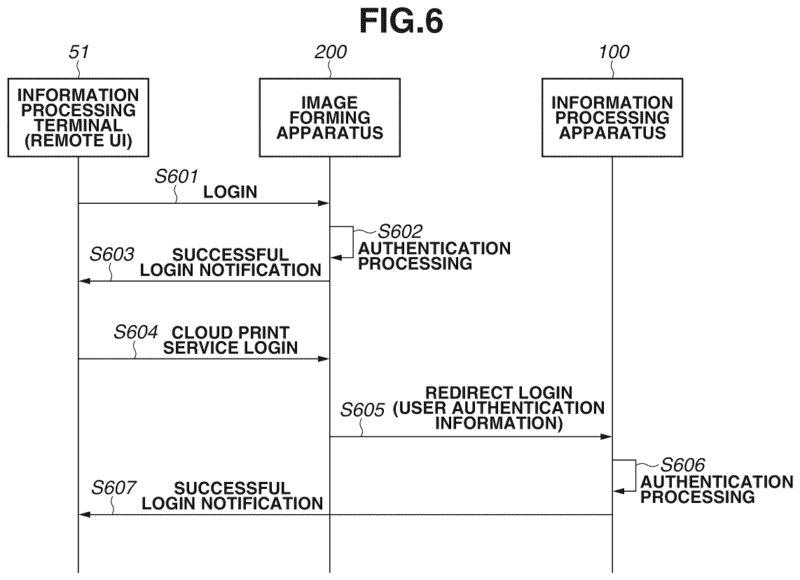

FIG. 6 is a sequence diagram illustrating processing for logging into the cloud print service 100 executed by the web service 311 of the image forming apparatus 200 according to the present exemplary embodiment. This processing starts when the user activates the web page display unit 520 such as the web browser of the information processing terminal 51, and then issues an instruction for accessing the web service 311 of the image forming apparatus 200.

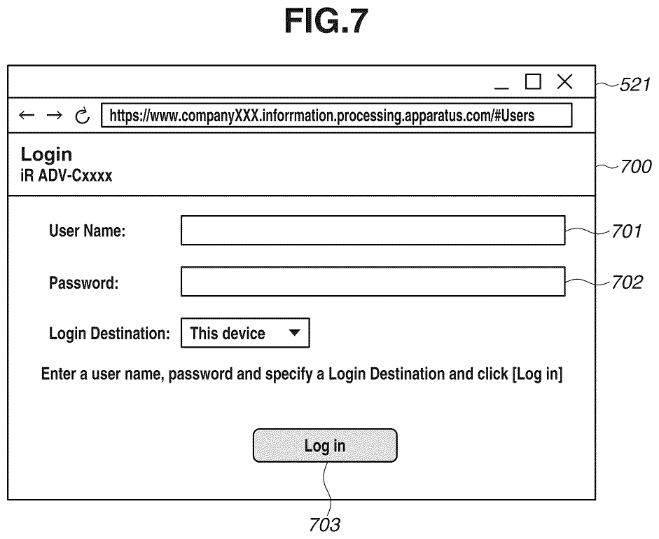

The information processing terminal 51 activates the web page display unit 520 based on a user instruction. In step S601, the information processing terminal 51 accesses the web service 311 of the image forming apparatus 200 and issues a login request to the image forming apparatus 200. For example, when the user inputs the URL and Internet Protocol (IP) address of the web service 311 of the image forming apparatus 200 in the web browser of the information processing terminal 51, the user can access the web service 311. Upon reception of the login request, the image forming apparatus 200 transmits information about the login screen to the information processing terminal 51. When the user input the user name and password registered to the image forming apparatus 200 in the login screen displayed on the information processing terminal 51, then in step S602, the image forming apparatus 200 performs the authentication processing. FIG. 7 illustrates an example of a login screen provided to the information processing terminal 51 by the image forming apparatus 200. When the user inputs the user name in a “User Name:” input field 701, the password in a “Password:” input field 702, and then click a [Log in] button 703, the image forming apparatus 200 starts the authentication processing.

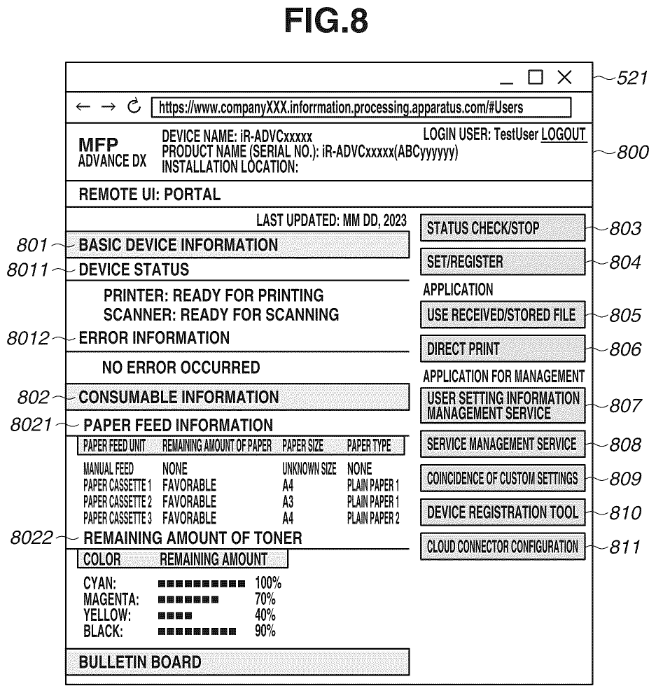

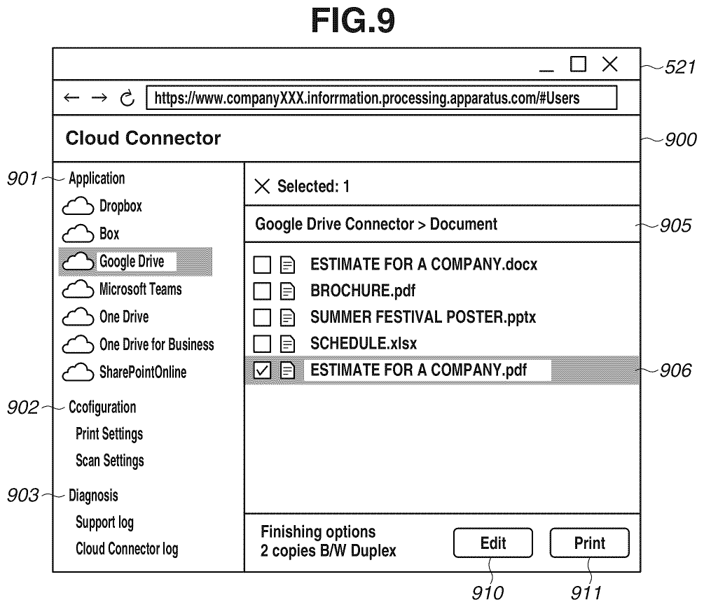

When the authentication processing is successfully completed, then in step S603, the image forming apparatus 200 transmits a successful login notification to the information processing terminal 51. The information processing terminal 51 makes a screen transition from the login screen to the main page screen. The main page screen includes information about the status of the image forming apparatus 200 and a user interface for performing various settings and remote operations on the image forming apparatus 200. FIG. 8 illustrates an example of the main page screen provided to the information processing terminal 51 by the image forming apparatus 200. The main page screen will be described below. The main page screen displays a button 811 (FIG. 8) for remotely operating the image forming apparatus 200 to access the cloud print service 100. When the button 811 is clicked, then in step S604, the information processing terminal 51 issues a request for logging into the cloud print service 100 to the image forming apparatus 200. Upon reception of the request for logging into the cloud print service 100, then in step S605, the image forming apparatus 200 issues a login request to the cloud print service 100 by using user information associated with the user currently logging into the image forming apparatus 200 from the information processing terminal 51. In step S606, the cloud print service 100 performs the authentication processing by using the received user information. In the authentication processing in step S606, the user information for logging into the cloud print service 100 may be input via the information processing terminal 51. When the authentication processing is successfully completed, then in step S606, the information processing apparatus 100 transmits a successful login notification to the information processing terminal 51 to make a screen transition to a main page of the cloud print service 100 as illustrated in FIG. 9.

FIG. 7 illustrates an example of a login screen of the web service provided by the image forming apparatus 200 (the login screen displayed in step S602) according to the present exemplary embodiment. A window 521 illustrated in FIG. 7 is a window of the web browser of the web page display unit 520 displayed on the display (not illustrated) of the information processing terminal 51.

The window of the web browser includes a title 700, a “User Name:” input field 701, a “Password:” input field, and a “Login Destination:” selection menu.

When the user inputs or selects these items and then click the [Log in] button 703, the authentication processing of the image forming apparatus 200 is started.

FIG. 8 illustrates an example of the main page screen of the web service provided by the image forming apparatus 200 (the main page screen displayed in step S603) according to the present exemplary embodiment. The window 521 illustrated in FIG. 8 is a window of the web browser of the web page display unit 520 displayed on the display (not illustrated) of the information processing terminal 51.

The main page of the web service includes a title 800, a basic device information field 801, a consumable information field 802, and various link movement instruction buttons 803 to 811. The device information field 801 includes a device status 8011 and error information 8012. The consumable information field 802 includes paper feed information 8021 and a remaining toner amount 8022. Detailed descriptions of the link movement instruction buttons 803 to 811 will be omitted. When the user clicks the link button 811 to the cloud print service, control is transferred to the link to the web portal provided by the cloud print service.

FIG. 9 illustrates an example of a web page screen provided by the cloud print service 100 (the main page screen of the cloud print service displayed in step S607) according to the present exemplary embodiment. The window 521 illustrated in FIG. 9 is a window of the web browser of the web page display unit 520 displayed on the display (not illustrated) of the information processing terminal 51.

The window of the web browser includes a title 900, menu screens 901 to 903, menu selection results 905 and 906, an [Edit] button 910, and a [Print] button 911 enabled when a file is selected. The menu screens include an application list 901 indicating cloud storage services accessible by the cloud print service 100, settings 902 of a print function and a scan function, and diagnosis results 903 including log information and reports. In this example, the cloud storage service “Google Drive” is selected, and a list of files stored in the “Document” folder of the cloud storage service “Google Drive” is displayed in the right-hand side pane. In the file list, a file 906 “Estimate for A Company.pdf” is selected.

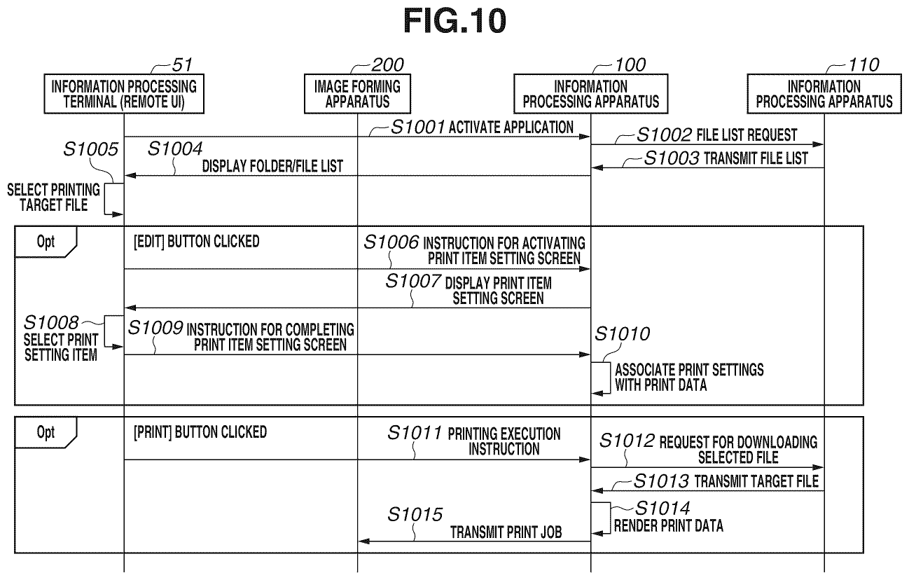

FIG. 10 is a sequence diagram illustrating procedures in which the web service 421 of the cloud print service 100 according to the present exemplary embodiment performs processing for printing a file stored in the cloud storage service 110. This processing is started, for example, when “Google Drive” of the “Application” category 901 is selected in the main page screen of the web service provided by the cloud print service 100 in FIG. 9. When “Google Drive” of the “Application” category 901 is selected on the information processing terminal 51, the information processing terminal 51 transmits an instruction for activating the “Google Drive” application to the cloud print service 100. In step S1001, the cloud print service 100 receives an instruction for activating the “Google Drive” application. In step S1002, the cloud print service 100 issues a file list request to the cloud storage service 110. The information processing apparatus 100 requests for a file list related to the relevant user based on information about the user who has logged into the cloud print service 100 in the authentication processing in step S606. In step S1003, the cloud print service 100 receives a file list from the cloud storage service 110. In step S1004, the cloud print service 100 provides the information processing terminal 51 with a file list. Then, the web browser of the information processing terminal 51 displays the received file list on the file list screen 905.

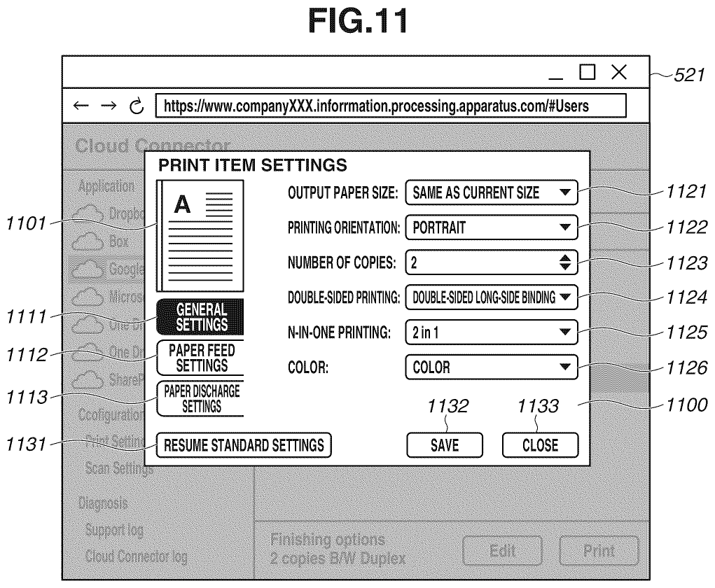

In step S1005, the user selects a printing target file via the information processing terminal 51. A sequence for changing the print item settings before printing (the sequence performed when the [Edit] button 910 is clicked) will be described below. When the [Edit] button 910 in FIG. 9 is clicked, the information processing terminal 51 transmits an instruction for activating the print item setting screen to the cloud print service 100. In step S1006, the cloud print service 100 receives the instruction for activating the print item setting screen. In step S1007, the cloud print service 100 transmits information about the print item setting screen to the information processing terminal 51, and the information processing terminal 51 displays a print item setting screen 1100 as illustrated in FIG. 11. FIGS. 11 to 13 will be described in detail below. In step S1008, the user selects and changes a desired print setting item in the print item setting screen in FIGS. 11 to 13. When the user clicks a [Save] button 1132, then in step S1009, the information processing terminal 51 transmits print setting information for the changed print setting item to the cloud print service 100 and completes the display of the print item setting screen 1100. Upon reception of the received print setting information, then in step S1010, the cloud print service 100 performs processing for storing the received print setting information in association with information about the selected printing target file (print data).

A sequence in which the user selects a printing target file in step S1005 and then performs printing (the sequence performed when the [Print] button 911 is clicked) will be described below. When the user clicks the [Print] button 911 in FIG. 9, the information processing terminal 51 transmits a printing execution instruction for printing the selected printing target file to the cloud print service 100. Printing execution processing in steps S1010 to S1015 can be performed even if the processing for changing the print item settings in step S1006 to S1010 is not performed. Upon reception of the printing execution instruction in step S1011, then in step S1012, the cloud print service 100 transmits an instruction for downloading the selected printing target file to the cloud storage service 110. In step S1013, the cloud storage service 110 transmits the relevant printing target file to the cloud print service 100. In step S1014, the cloud print service 100 renders the printing target file received in step S1013, according to information to be used for rendering out of the print setting information associated in step S1010. Upon completion of the rendering processing, then in step S1015, the cloud print service 100 generates a print job based on the data after the rendering processing and information to be used in the print processing by the image forming apparatus out of the print setting information, and transmits the print job to the image forming apparatus 200. The image forming apparatus 200 performs the print processing according to the received print job.

FIG. 11 illustrates an example of a print item setting screen displayed in step S1007 when the user clicks the [Edit] button 910 in FIG. 9 (i.e., when the user issues an editing instruction). When the user clicks the [Edit] button 910 displayed in the window 521 of the web browser in FIG. 9, the print item setting screen 1100 appears as a sub-window of the window of the web browser in step S1007.

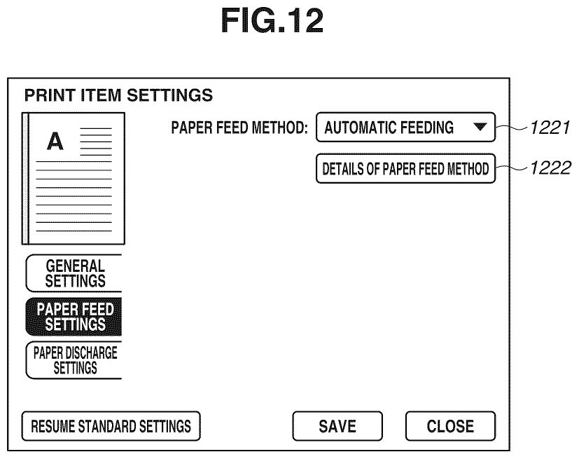

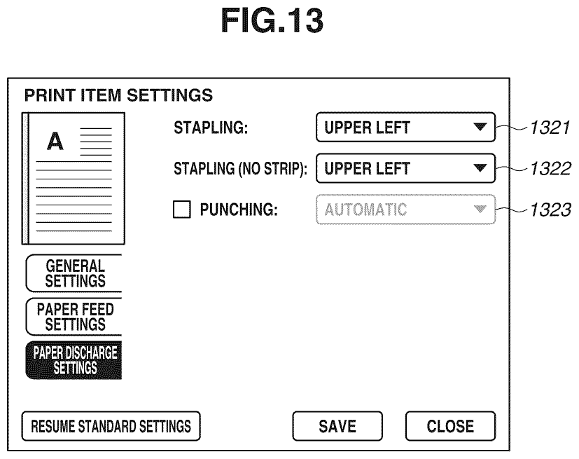

The print item setting screen 1100 includes a print preview screen 1101, sheet tabs 1111 to 1113 for different print item categories, print items 1121 to 1126, and operation buttons 1131 to 1133. The sheet tabs for different print item categories include a General Settings sheet tab 1111, a Paper Feed Settings sheet tab 1112, and a Paper Discharge Settings sheet tab 1113. The print items 1121 to 1126 in FIG. 11 appear when the General Settings sheet tab 1111 is selected. For the General Settings sheet tab 1111, settable and changeable setting items include an output paper size 1121, a printing orientation 1122, the number of copies 1123, double-sided printing 1124, N-in-one printing 1125, and color 1126. Print items to be displayed when the Paper Feed Settings sheet tab 1112 and the Paper Discharge Settings sheet tab 1113 are selected will be described below with reference to FIGS. 12 and 13. The print preview screen 1101 displays a preview of a result of summarizing the print item settings. The [Resume Standard Settings] button 1131 is used to resume the standard print items registered in the cloud print service 100. The [Save] button 1132 is used to associate the selected document data with the print items after setting and change, as described above in step S1010 in FIG. 10. The [Close] button 1133 is used to close the print item setting screen with no operation. The print preview screen 1101, the [Resume Standard Settings] button 1131, the [Save] button 1132, and the [Close] button 1133 also appear when the Paper Feed Settings sheet tab 1112 or the Paper Discharge Settings sheet tab 1113 is selected.

FIG. 12 illustrates an example of a print item setting screen to be displayed when the Paper Feed Settings sheet tab 1112 is selected. The paper feed sheet includes a paper feed method setting 1221 and a [Details of Paper Feed Method] button 1222. The [Details of Paper Feed Method] button 1222 is used to set details of the paper feed method selected with the paper feed method setting 1221, and the detailed description thereof will be omitted.

FIG. 13 illustrates an example of a print item setting screen to be displayed when the Paper Discharge Settings sheet tab 1113 is selected. The paper discharge sheet includes a stapling position setting 1321, a stapling position (no strip) setting 1322, and a punch hole setting 1323.

When the image forming apparatus 200 prints a file stored in the cloud storage via the cloud print service 100, the above-described processing makes it possible to make various print settings without installing any special application such as a printer driver in the information processing terminal 51.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-166775, filed Sep. 28, 2023, which is hereby incorporated by reference herein in its entirety.

What is claimed is:

1. A cloud server for providing a cloud print service, the cloud server comprising:
at least one memory that stores instructions; and
at least one processor that executes the instructions to:
receive a login request from an image forming apparatus remotely operated by an information processing terminal;
acquire a file list from a cloud storage service based on user information acquired in response to the received login request;
transmit the acquired file list to the information processing terminal;
provide the information processing terminal with a setting screen for changing print settings regarding a printing target file selected from the file list;
download the printing target file from the cloud storage service in a case where a printing execution instruction for printing the printing target file is received from the information processing terminal;
generate a print job based on the downloaded printing target file and the print settings changed in the setting screen; and
transmit the generated print job to the image forming apparatus.

2. The cloud server according to claim 1, wherein, when a user of the information processing terminal selects the printing target file from the file list and issues an editing instruction, the setting screen is provided to the information processing terminal.

3. The cloud server according to claim 1, wherein at least one processor stores the print settings changed in the setting screen, in association with the printing target file, in a case where changes of the print settings in the setting screen are completed.

4. The cloud server according to claim 1, wherein the print job is generated in a case where the user of the information processing apparatus issues a printing execution instruction.

5. The cloud server according to claim 1, wherein the print job is generated by rendering the printing target file downloaded from the cloud storage, according to the print settings changed in the setting screen.

6. The cloud server according to claim 1, wherein, in a case where the user of the information processing apparatus operates a button for causing the image forming apparatus to access the cloud print service in a screen for remotely operating the image forming apparatus, the image forming apparatus issues the login request.

7. A non-transitory computer-readable storage medium that stores instructions for providing a cloud print service, wherein the instructions, when executed by at least one processor of a cloud server, cause the cloud server to:
receive a login request from an image forming apparatus remotely operated by an information processing terminal;
acquire a file list from a cloud storage service based on user information acquired in response to the received login request;
transmit the acquired file list to the information processing terminal;
provide the information processing terminal with a setting screen for changing print settings regarding a printing target file selected from the file list;
download the printing target file from the cloud storage service in a case where a printing execution instruction for printing the printing target file is received from the information processing terminal;
generate a print job based on the downloaded printing target file and the print settings changed in the setting screen; and
transmit the generated print job to the image forming apparatus.

8. The non-transitory computer-readable storage medium according to claim 7, wherein, in a case where a user of the information processing terminal selects the printing target file from the file list and issues an editing instruction, the setting screen is provided to the information processing terminal.

9. The non-transitory computer-readable storage medium according to claim 7, wherein the instructions further cause any of the at least one processor to store the print settings changed in the setting screen, in association with the printing target file, in a case where changes of the print settings in the setting screen are completed.

10. The non-transitory computer-readable storage medium according to claim 7, wherein the print job is generated in a case where the user of the information processing apparatus issues a printing execution instruction.

11. The non-transitory computer-readable storage medium according to claim 7, wherein the print job is generated by rendering the printing target file downloaded from the cloud storage, according to the print settings changed in the setting screen.

12. The non-transitory computer-readable storage medium according to claim 7, wherein, in a case where the user of the information processing apparatus operates a button for causing the image forming apparatus to access the cloud print service in a screen for remotely operating the image forming apparatus, the image forming apparatus issues the login request.

13. A method executed by a cloud server for providing a cloud print service, the method comprising:
receiving a login request from an image forming apparatus remotely operated by an information processing terminal;
acquiring a file list from a cloud storage service based on user information acquired in response to the received login request;
transmitting the acquired file list to the information processing terminal;
providing the information processing terminal with a setting screen for changing print settings regarding a printing target file selected from the file list;
downloading the printing target file from the cloud storage service in a case where a printing execution instruction for printing the printing target file is received from the information processing terminal;
generating a print job based on the downloaded printing target file and the print settings changed in the setting screen; and
transmitting the generated print job to the image forming apparatus.
